(19) United States
(12) Patent Application Publication
(10) Pub. No.: US 2026/0042402 A1
(43) Pub. Date: Feb. 12, 2026

(54) Lift System

(71) Applicant: Harmar Mobility, LLC, Sarasota, FL (US)

(72) Inventors: Jeffrey Dale Limbaugh, Parrish, FL (US); Erik Steven Brown, Sarasota, FL (US); Thomas Kolangayil James, Sarasota, FL (US); Alan Philip Seidel, Gainesville, FL (US); Jana Wingate, Venice, FL (US); David Russell Baxter, Sarasota, FL (US); Steven Ronald Wharton, Rotonda West, FL (US); Jeffrey Len Fielder, Sarasota, FL (US); Joel Raymond Charftier, Blowing Rock, NC (US); Matthew William Vergin, Saint Petersburg, FL (US); Robert Owen Brady, Sarasota, FL (US)

(73) Assignee: Harmar Mobility, LLC, Sarasota, FL (US)

(21) Appl. No.: 19/297,843

(22) Filed: Aug. 12, 2025

Related U.S. Application Data
(60) Provisional application No. 63/682,312, filed on Aug. 12, 2024.

(51) Int. Cl. B60R 9/06; A61G 3/08

(52) U.S. Cl. CPC B60R 9/06; A61G 3/0808

(57) ABSTRACT

Systems, apparatuses, and methods for a lift system configured to engage with the rear portion of an automobile are disclosed. The lift system can include a lift assembly. The lift assembly can include a platform. The platform can have a first rail and a second rail and each of the rails can be configured to be rotatably engaged with a support bar. The lift system can also include a lift mechanism having a telescoping support and a drive assembly. The lift assembly can be moved between a stowed position, a loading position, and a carrying position

### CROSS REFERENCE TO RELATED APPLICATION(S)

This is a utility application claiming priority to and incorporating by reference provisional application entitled LIFT SYSTEM, Ser. No. 63/682,312 filed Aug. 12, 2024.

### TECHNICAL FIELD

This disclosure relates to lift systems designed to connect to the rear of an automobile, such as the automobile hitch, and designed to carry a personal mobility vehicle such as a wheelchair, scooter, power wheelchair, bike/e-bike, and/or similar device. More particularly, this disclosure relates to low-profile lift systems that may allow for an automobile hatch or rear door to be opened while the lift system is connected to the automobile hitch. Similarly, the lift system may allow for visibility of the license plate when the lift system is in the stowed position and provide visibility out of a back window of the automobile.

### BACKGROUND

Many lift systems exist that are designed to carry a personal mobility devices such as a wheelchair, scooter, power wheelchair, bike/e-bike, and/or similar device on the rear of an automobile. This disclosure relates primarily to lower height lift systems that may allow a user to more easily operate the automobile while the lift system is connected to the automobile. In some embodiments the rear door of the automobile may be able to be opened without having to move the lift system.

### SUMMARY

The following presents a simplified summary of the present disclosure in order to provide a basic understanding of example aspects described herein. This summary is not an extensive overview, and is not intended to identify key or critical elements or to delineate the scope of the claims. The following summary merely presents various described aspects in a simplified form as a prelude to the more detailed description provided below.

Aspects of the disclosure provide technical solutions that overcome one or more of the technical problems described above and/or other technical challenges. For instance, one or more aspects of the disclosure relate to systems, methods, and apparatuses for a lift system engaged with an automobile. In one aspect this disclosure provides a lift system configured to engage with a rear portion of an automobile. The lift system can include an engagement post, configured to engage a hitch of an automobile; a vertical post, the vertical post engaged with the engagement post; a lift assembly, the lift assembly can be engaged with the vertical post. The lift assembly can include a support bar having a first end and a second end; a platform, having a first rail having an outward end and an inward end engaged with the first end of the support bar, the first rail rotatably engaged with the support bar, and a second rail having an outward end and an inward end engaged with the second end of the support bar, the second rail rotatably engaged with the support bar. The lift system may also include a lift mechanism, the lift mechanism having a telescoping support; and a drive assembly, the drive assembly configured to extend and retract the telescoping support. The lift assembly is configured to be moved between a stowed position, a loading position, and a carrying position.

The first rail and the second rail can be configured to rotate such that the outwards ends extend substantially parallel to each other and away from the support bar when the lift assembly is in the loading position. The first rail and the second rail can be configured to rotate such that the outward end of the first rail extends toward the inward end of the second rail and the outward end of the second rail extends toward the inward end of the first rail when the lift assembly is in the stowed position. The first rail can be vertically below the second rail when the lift assembly is in the stowed position.

The lift system can also include a roller engaged with the lift assembly, the roller can be configured to engage the vertical post. The lift assembly can be configured to tilt backward in the stowed position.

The lift system can also include hold-down bar, the hold-down bar can be configured to engage a personal mobility vehicle in the carrying position. The lift system can also include a sensor on the hold-down bar, wherein the sensor is configured to sense that hold-down bar is engaged with the personal mobility vehicle.

The first end of the support bar can include a first rail drive assembly configured to rotate the first rail. The second end of the support bar can include a second rail drive assembly configured to rotate the second rail.

The height of the vertical post relevant to the engagement post can be adjustable. The width of the support bar can be adjustable.

The lift system can be configured to allow a user to open a rear door of an automobile engaged with the lift system when the lift system is in the stowed position. The lift system can be entirely below a license plate of an automobile engaged with the lift system when the lift system is in the stowed position. The lift system can be entirely below a rear window of an automobile engaged with the lift system when the lift system is in the stowed position.

In another aspect this disclosure provides a lift system configured to engage with a rear portion of an automobile. The lift system can include a lift assembly, the lift assembly having a support bar having a first end and a second end; a platform having a first rail having an outward end and an inward end engaged with the first end of the support bar, the first rail rotatably engaged with the support bar; and a second rail having an outward end and an inward end engaged with the second end of the support bar, the second rail rotatably engaged with the support bar; and a lift mechanism having a telescoping support; and a drive assembly, the drive assembly configured to extend and retract the telescoping support. The lift assembly can be moved between a stowed position, a loading position, and a carrying position.

The first rail and the second rail can be configured to rotate such that the outward ends extend substantially parallel to each other and away from the support bar when the lift assembly is in the loading position. The first rail and the second rail can be configured to rotate such that the outward end of the first rail extends toward the inward end of the second rail and the outward end of the second rail extends toward the inward end of the first rail when the lift assembly is in the stowed position.

The lift system can also include a controller configured to operate the lift assembly by moving the assembly between the stowed position, loading position, and carrying position, wherein the controller is configured to operate the lift assembly only when the controller is within a specified distance from the lift system. The lift system can also include a controller configured to operate the lift assembly by moving the assembly between the stowed position, loading position, and carrying position, wherein the lift system is configured to enter a lower power state after a set amount of time after a last communication from the controller.

The lift system can also include a current sensor connected to the drive assembly. The current sensor can be configured to determine whether the lift assembly has impacted an obstacle. The current sensor can be configured to determine whether a personal mobility vehicle is loaded on the lift system.

In another aspect this disclosure provides a lift system configured to engage with a rear portion of an automobile. The lift system can include a lift assembly having a platform; and a lift mechanism engaged with the platform, the lift mechanism having a telescoping support; and a drive assembly, the drive assembly configured to extend and retract the telescoping support. The lift assembly can be moved between a stowed position, a loading position, and a carrying position. The lift assembly can have a height measured from a bottom of the lift system to a top of the lift system of about 10 inches to 22 inches when the lift assembly is in the stowed position.

The summary here is not an exhaustive listing of the novel features described herein, and are not limiting of the claims. These and other features are described in greater detail below.

### DESCRIPTION OF THE DRAWINGS

To allow for a more full understanding of the present disclosure, it will now be described

by way of example, with reference to the accompanying drawings in which:

FIG. 1 illustrates a back view of an exemplary lift system in a stowed position engaged with an automobile, in accordance with aspects of the disclosure;

FIG. 2 illustrates a side view of the exemplary lift system of FIG. 1 shown in a stowed position;

FIG. 3 illustrates a back perspective of the exemplary lift system of FIG. 1 shown in a stowed position;

FIG. 4 illustrates a back perspective of the exemplary lift system of FIG. 1 shown in an opening position;

FIG. 5 illustrates a back perspective of the exemplary lift system of FIG. 1 shown in an opened and up position;

FIG. 6 illustrates a back perspective of the exemplary lift system of FIG. 1 shown in a loading position;

FIG. 7 illustrates a back perspective of the exemplary lift system of FIG. 1 shown in a loading position with a personal mobility vehicle;

FIG. 8 illustrates a back perspective of the exemplary lift system of FIG. 1 shown in a carrying position with a personal mobility vehicle;

FIG. 9 illustrates a back perspective of the exemplary lift system of FIG. 1 shown in an opened and up position showing details of the movement system;

FIG. 10 illustrates a back perspective view of another embodiment of exemplary lift system in a stowed position engaged with an automobile, in accordance with aspects of the disclosure;

FIG. 11 illustrates a side view of the exemplary lift system of FIG. 10 shown in a stowed position;

FIG. 12 illustrates a back perspective view of the exemplary lift system of FIG. 10 shown in an opening position;

FIG. 13 illustrates a back perspective view of the exemplary lift system of FIG. 10 shown in an opened and up position;

FIG. 14 illustrates a back perspective view of the exemplary lift system of FIG. 10 shown in a loading position;

FIG. 15 illustrates a back perspective of the exemplary lift system of FIG. 10 shown in a loading position with a personal mobility vehicle;

FIG. 16 illustrates a back perspective of the exemplary lift system of FIG. 10 shown in an carrying position with a personal mobility vehicle;

FIG. 17 illustrates a back perspective view of another embodiment of an exemplary lift system in a loading position engaged with an automobile, in accordance with aspects of the disclosure;

FIG. 18 illustrates a back perspective view of the exemplary lift system of FIG. 18 shown in an upward position;

FIG. 19 illustrates a back perspective view of another embodiment of an exemplary lift system in a loading position engaged with an automobile, in accordance with aspects of the disclosure;

FIG. 20 illustrates a back perspective view of the exemplary lift system of FIG. 19 shown in an upward position;

FIG. 21 illustrates a back perspective view of another embodiment of an exemplary lift system in a loading position engaged with an automobile, in accordance with aspects of the disclosure;

FIG. 22 illustrates a back perspective view of the exemplary lift system of FIG. 21 shown in an upward position;

FIG. 23 illustrates a back perspective view of another embodiment of an exemplary lift system in a loading position engaged with an automobile, in accordance with aspects of the disclosure;

FIG. 24 illustrates a back perspective view of the exemplary lift system of FIG. 23 shown in an upward position;

FIG. 25 illustrates a back perspective view of another embodiment of an exemplary lift system in a loading position engaged with an automobile, in accordance with aspects of the disclosure;

FIG. 26 illustrates a back perspective view of the exemplary lift system of FIG. 25 shown in an upward position;

FIG. 27 illustrates a back-perspective view of another embodiment of an exemplary lift system in a loading position engaged with an automobile, in accordance with aspects of the disclosure;

FIG. 28 illustrates a back-perspective view of the exemplary lift system of FIG. 27 shown in an upward position;

FIG. 29 illustrates a back-perspective view of another embodiment of an exemplary lift system in a loading position engaged with an automobile, in accordance with aspects of the disclosure; and

FIG. 30 illustrates a back-perspective view of the exemplary lift system of FIG. 29 shown in an upward position.

FIG. 31A illustrates a back-perspective view of another embodiment of an exemplary lift system in a stowed position, in accordance with aspects of the disclosure;

FIG. 31B illustrates a right side view of the exemplary lift system of FIG. 31A shown in a stowed position;

FIG. 31C illustrates a left side view of the exemplary lift system of FIG. 31A shown in a stowed position;

FIG. 31D illustrates a back view of the exemplary lift system of FIG. 31A shown in a stowed position;

FIG. 32A illustrates a back-perspective view of the exemplary lift system of FIG. 31A in a downward loading position, in accordance with aspects of the disclosure;

FIG. 32B illustrates a right side view of the exemplary lift system of FIG. 31A shown in a downward loading position;

FIG. 32C illustrates a left side view of the exemplary lift system of FIG. 31A shown in an a downward loading position;

FIG. 32D illustrates a back view of the exemplary lift system of FIG. 31A shown in an a downward loading position;

FIG. 33A illustrates a back-perspective view of the exemplary lift system of FIG. 31A in an upward loaded or carrying position, in accordance with aspects of the disclosure;

FIG. 33B illustrates a right side view of the exemplary lift system of FIG. 31A shown in an upward loaded or carrying position;

FIG. 33C illustrates a left side view of the exemplary lift system of FIG. 31A shown in an upward loaded or carrying position;

FIG. 33D illustrates a back view of the exemplary lift system of FIG. 31A shown in an upward loaded or carrying position;

FIG. 34A illustrates a back-perspective view of the exemplary lift system of FIG. 31A showing internal components of the system;

FIG. 34B illustrates a back-perspective view of the exemplary lift system of FIG. 31A showing a close-up view of the internal components shown in FIG. 34A;

FIG. 35 illustrates a perspective view of an exemplary embodiment of a controller for a lift system, in accordance with aspects of the disclosure.

### DETAILED DESCRIPTION

While this invention is susceptible of embodiments in many different forms, there are shown in the drawings and will herein be described in detail example embodiments of the invention with the understanding that the present disclosure is to be considered as an exemplification of the principles of the invention and is not intended to limit the broad aspect of the invention to the embodiments illustrated. In the following description of various example structures according to the invention, reference is made to the accompanying drawings, which form a part hereof, and in which are shown by way of illustration various example devices, systems, and environments in which aspects of the invention may be practiced. It is to be understood that other specific arrangements of parts, example devices, systems, and environments may be utilized and structural and functional modifications may be made without departing from the scope of the present invention.

Also, while the terms “top,” “bottom,” “front,” “back,” “side,” “distal,” and the like may be used in this specification to describe various example features and elements of the invention, these terms are used herein as a matter of convenience, e.g., based on the example orientations shown in the figures or the orientation during typical use. Nothing in this specification should be construed as requiring a specific three-dimensional orientation of structures in order to fall within the scope of this invention. Also, the reader is advised that the attached drawings are not necessarily drawn to scale.

The following terms are used in this specification, and unless otherwise noted or clear from the context, these terms have the meanings provided below.

“Plurality,” as used herein, indicates any number greater than one, either disjunctively or conjunctively, as necessary, up to an infinite number.

In general, this disclosure relates to lift systems attached to automobiles that are configured to carry a personal mobility device. The mobility device can include vehicles such as a wheelchair, scooter, power wheelchair, bike/e-bike, and/or similar device. More particularly, this disclosure relates to lower height lift systems that may allow for an automobile hatch or rear door to be opened while the lift system is connected to the automobile hitch without moving the lift system from the stowed position. Similarly, the lift system may allow for visibility of the license plate when the lift system is connected to the automobile hitch and provide visibility out of a back window of the automobile for a user of the automobile. Additionally, the lift system may be mounted in such a way that it does not obstruct the automobile's rear-view camera when the lift system is connected to the automobile.

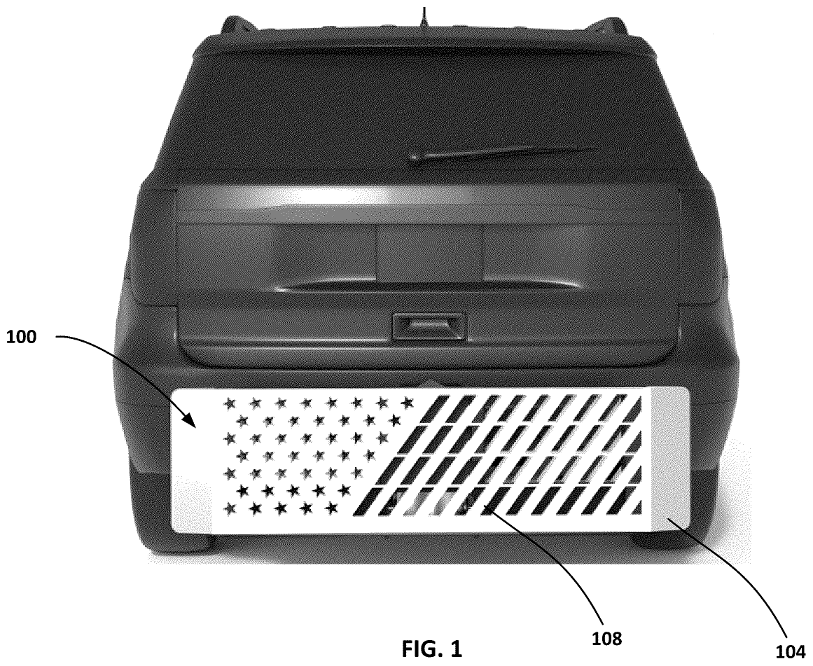

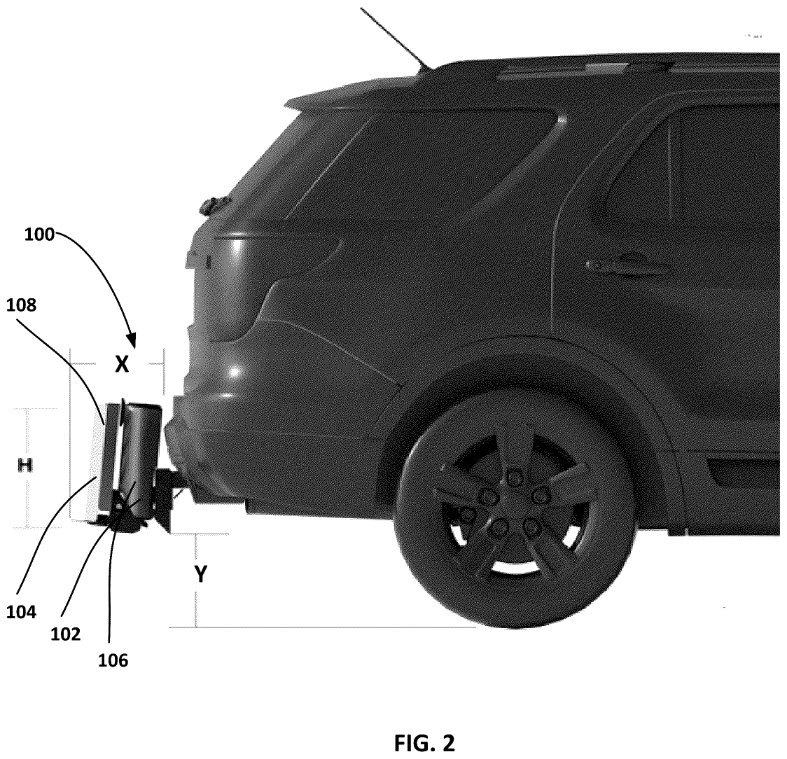

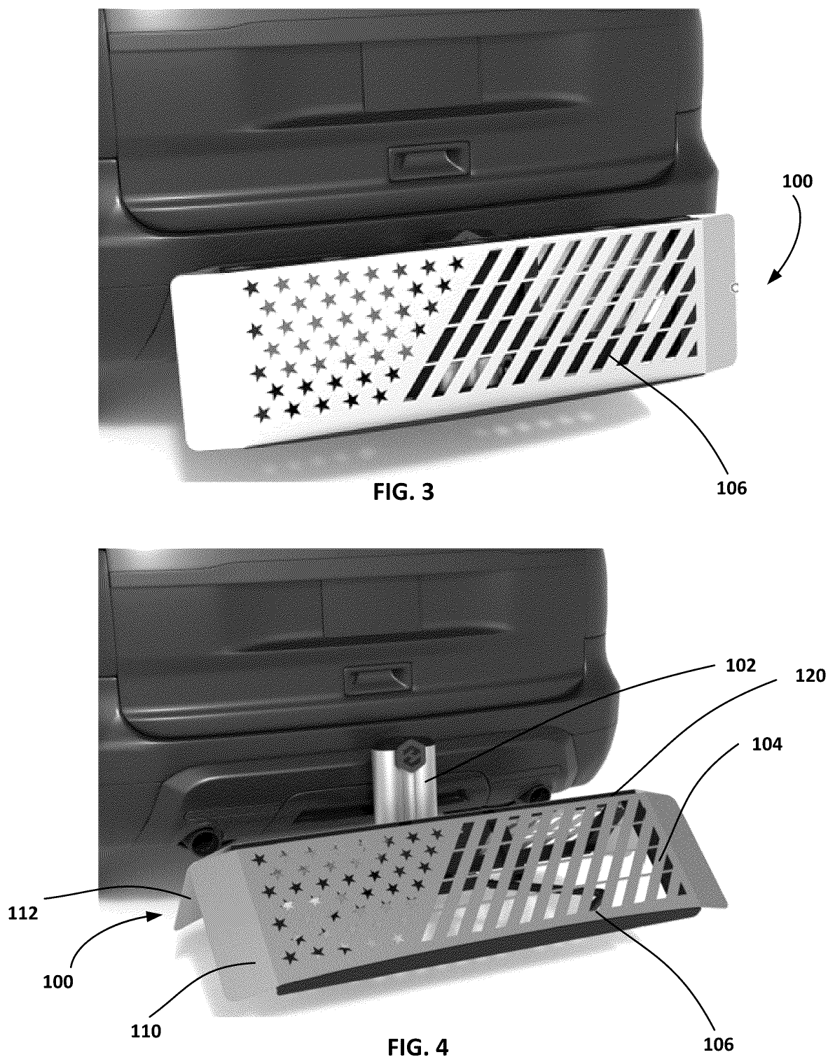

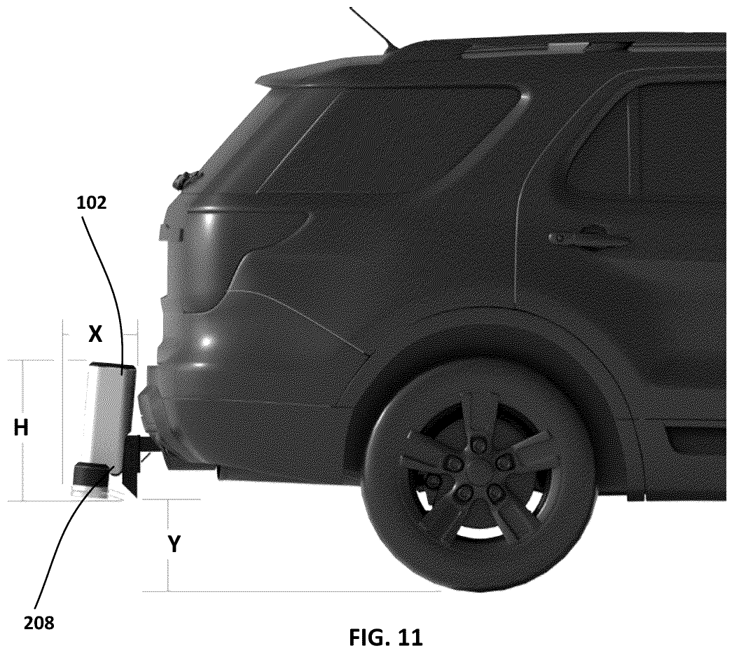

FIGS. 1-9 illustrate aspects of one embodiment of a lift system 100. The lift system 100 is configured to engage the rear portion of an automobile. As best shown, for example, in FIG. 2 the lift system 100 can be configured to engage the hitch of an automobile. As shown in FIGS. 1-9, the lift system includes a lift mechanism 102 and the lift mechanism 102 is configured to move the platform 104 between an up position (shown for example in FIG. 3) and a down position (shown for example in FIG. 6). The lift system 100 as shown in FIGS. 1-9 is a telescoping lift system 106. In particular the lift system 100 shown in FIGS. 1-9 is a double telescoping lift system having a motor mounted between two telescoping assemblies that drives the telescoping assemblies up and down through a belt or chain. However, as shown and described below, additional lift systems may be used. For example, a single telescoping lift system is shown in FIGS. 11-16.

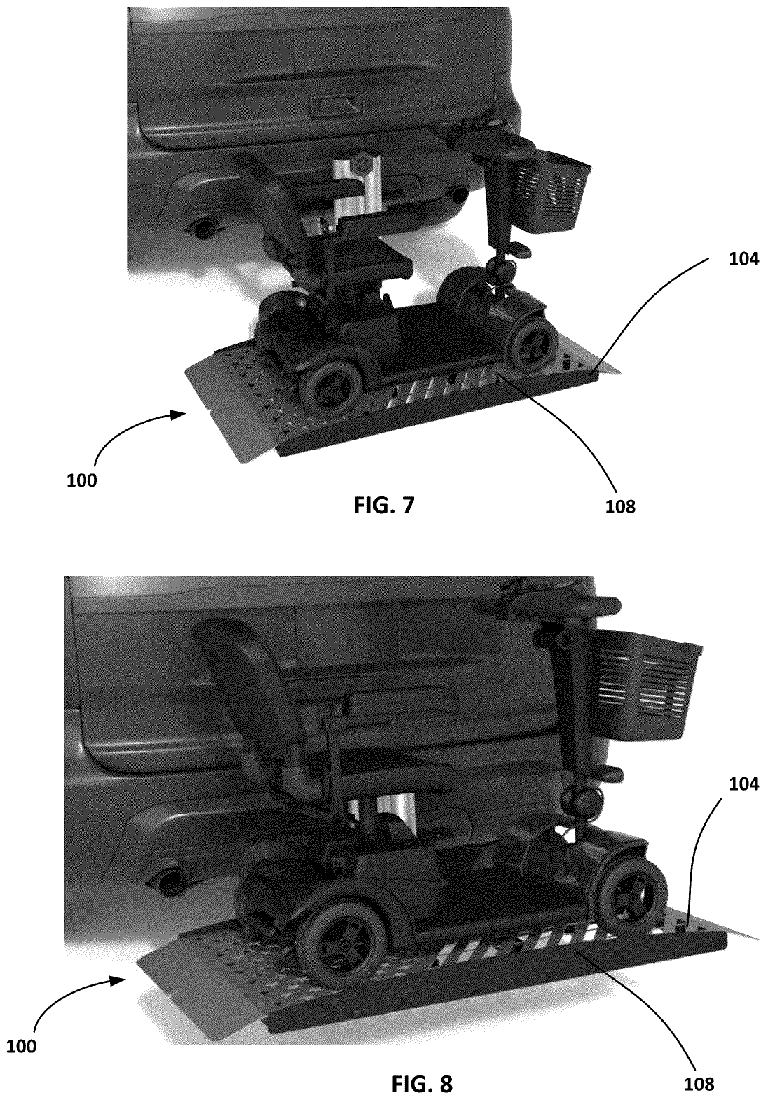

The platform 104 is configured to move between a stowed position (FIGS. 1-3), wherein the lift system 100 is not carrying a personal mobility device; a loading position (FIGS. 6-7), wherein personal mobility devices may be loaded on to the platform; and a carrying position (FIG. 8), wherein the personal mobility device is loaded on to the platform and the automobile may be driven while carrying the personal mobility device.

As best shown for example in FIGS. 1-2, the lift system 100 is configured to allow a user to open the rear door of an automobile while the lift system 100 is in the stowed position. Similarly, the lift system 100 may be below or entirely below the license plate of an automobile when the lift system is in the stowed position. Additionally, the lift system 100 may be below or entirely below the rear window of an automobile when the lift system is in the stowed position. Further, the lift system 100 may be mounted in such a way that it does not obstruct the automobile's rear-view camera when the lift system is connected to the automobile. Advantageously this allows a user better and safer operation of the automobile by allowing a user easier access to the trunk of the automobile, allowing a user to see out of the rear window of the automobile, and allowing the license plate of the automobile to be visible.

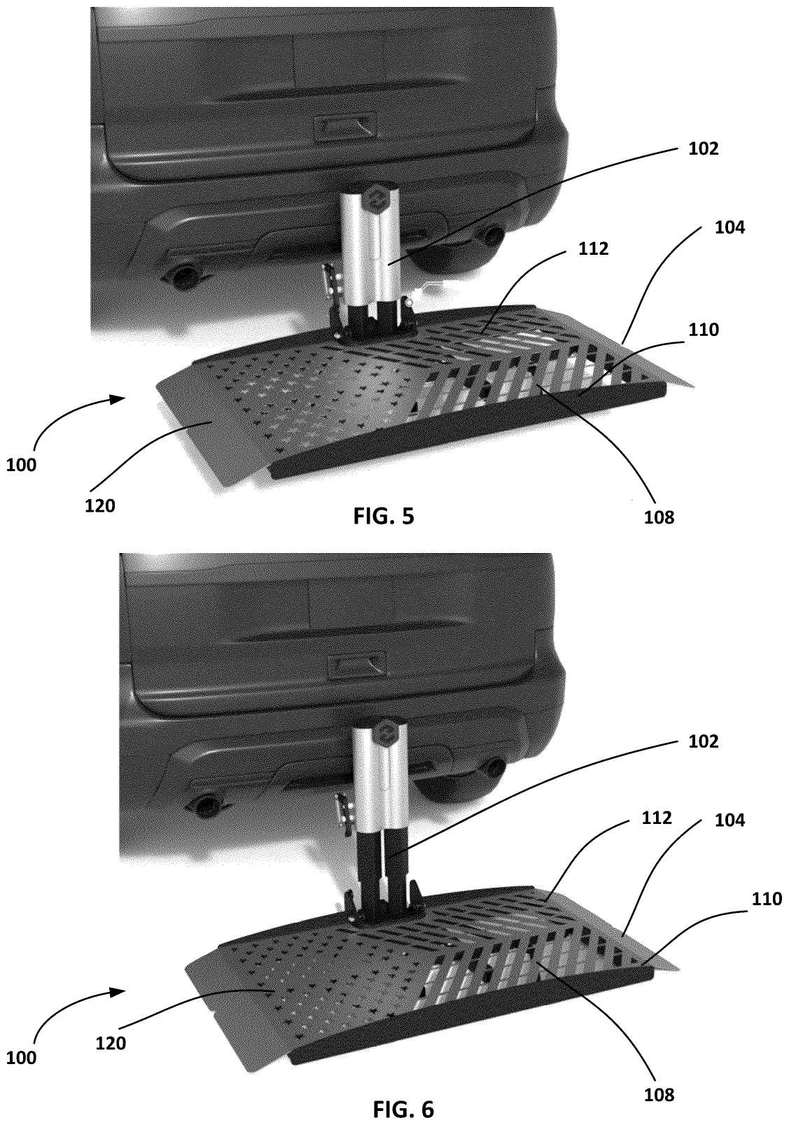

In one embodiment, the platform 104 can be a folding platform 108. As shown in FIGS. 1-9 the folding platform 108 can include a first portion 110 and a second portion 112. The first portion 110 and the second portion 112 can be configured to rotate relative to each other about a hinge portion 120. The process of moving the lift system 100 from the stowed position, through the loading position, to the carrying position is shown in FIGS. 3-8. As shown in FIG. 3, the lift system 100 is shown in the stowed position. A user may operate a controller (not shown) to open the folding platform 108 and lower the platform 108. The platform 108 is shown in FIG. 4 partially unfolded. The platform 108 is shown in FIG. 5 in the unfolded and up position and is then lowered to the loading position which is shown in FIG. 6. A personal mobility device is loaded on to the platform in the loading position as shown in FIG. 7. Then the platform 108 is raised to the carrying position as shown in FIG. 8.

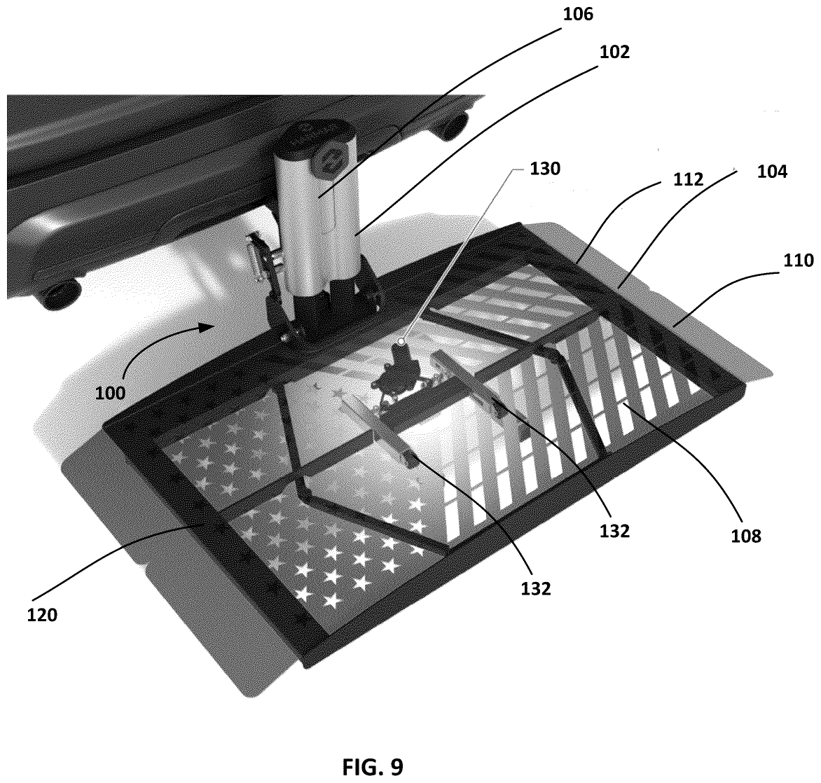

As best shown in FIG. 9, the platform 108 may be moved between the folded and unfolded position using motor 130 which may drive one or more tubes 132 into tubes (now shown) on the first portion 110 which can lock both portions flat. The tubes 132 are removed to unlock the first portion 110 and the second portion 112 so that they can be returned to the stowed position.

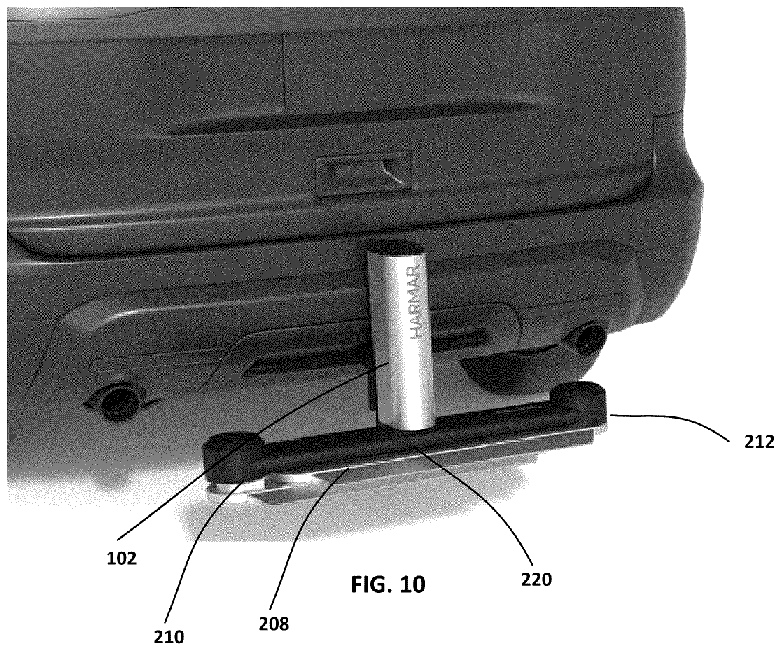

In other embodiments, the platform 104 can have different arrangements and can comprise different mechanisms to move the platform 104 to the stowed position. As shown in FIGS. 10-16 the platform 104 can comprise a rotating platform 208. The platform 208 can comprise a first rail 210 and a second rail 212. As shown in FIGS. 10-16 the rails 210, 212 can be rotated inward to a stowed position and outward to a carrying position such that the rails 210, and 212 can support the wheels of a personal mobility device. The platform 208 can include a horizonal bar 220 which supports the rails 210, 212. Motors (not shown) can be situated in the ends of the horizonal bar 202 which may rotate the rails 210, 212. In one embodiment, the rails 210, 212 can be made of steel tubes with ramps welded onto the long ends. In one embodiment, the rails 210, 212 may be at different heights in the stowed position but may be at substantially equal heights in the carrying position. In some embodiments, the distance between the rails 210, 212 may be adjustable along the horizontal bar 220 such that the rails can be adjusted for different sized personal mobility devices.

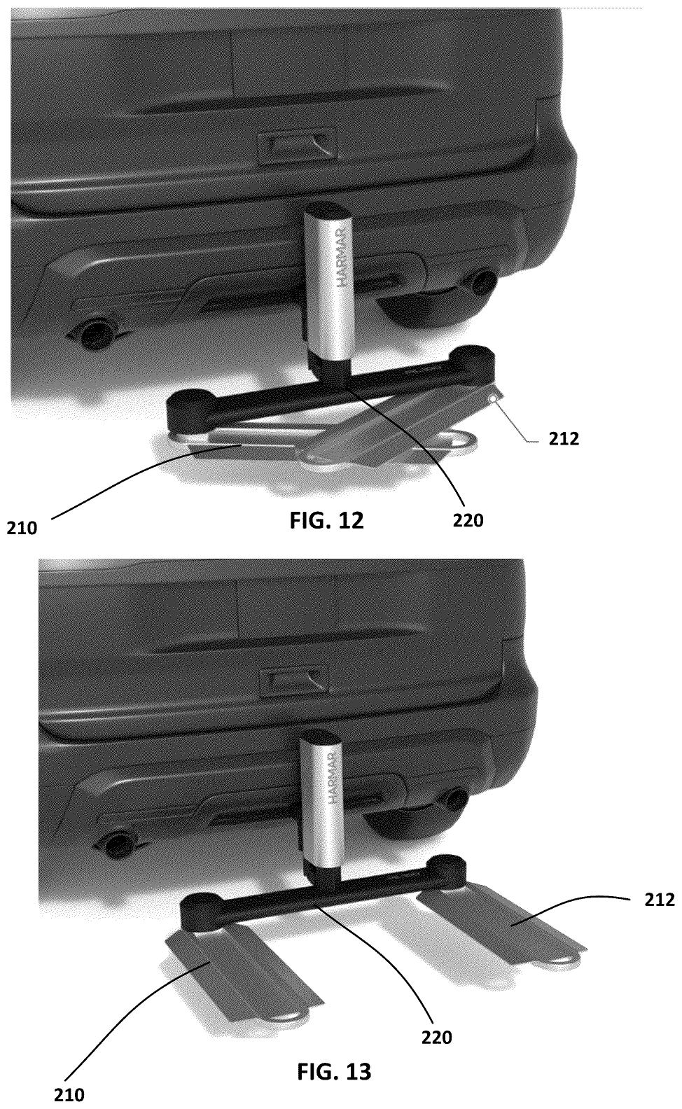

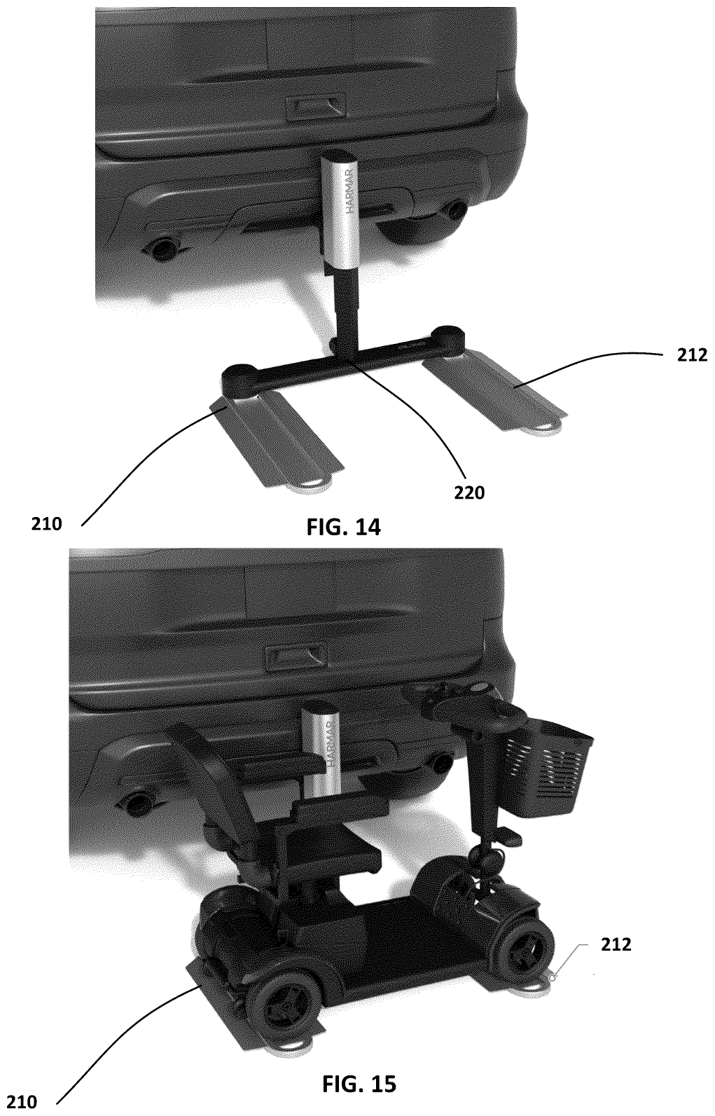

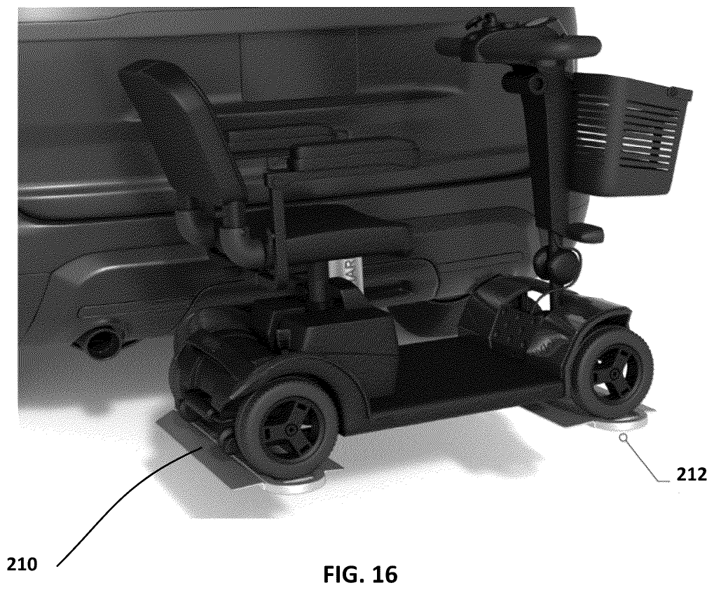

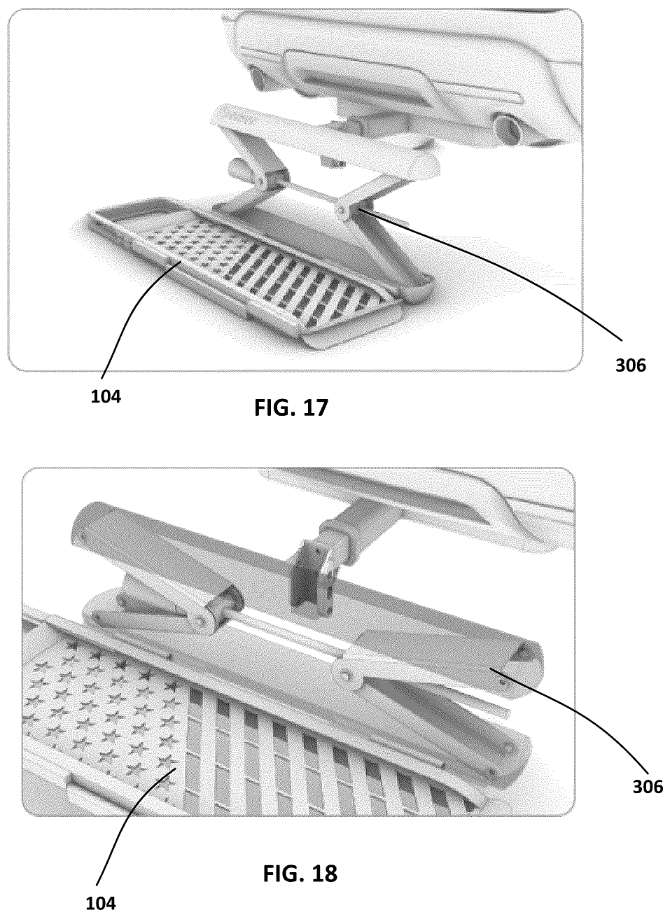

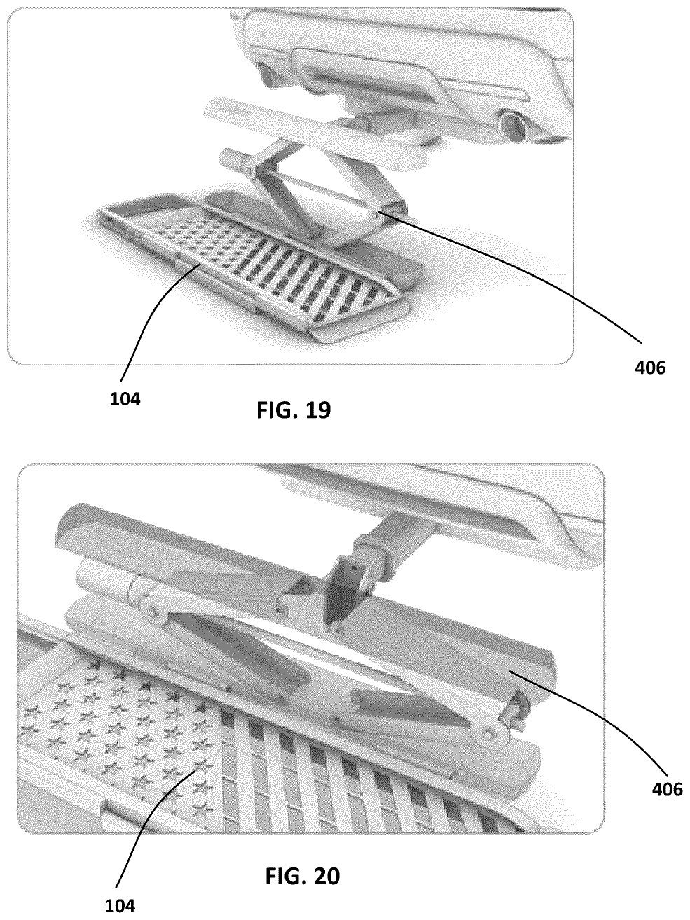

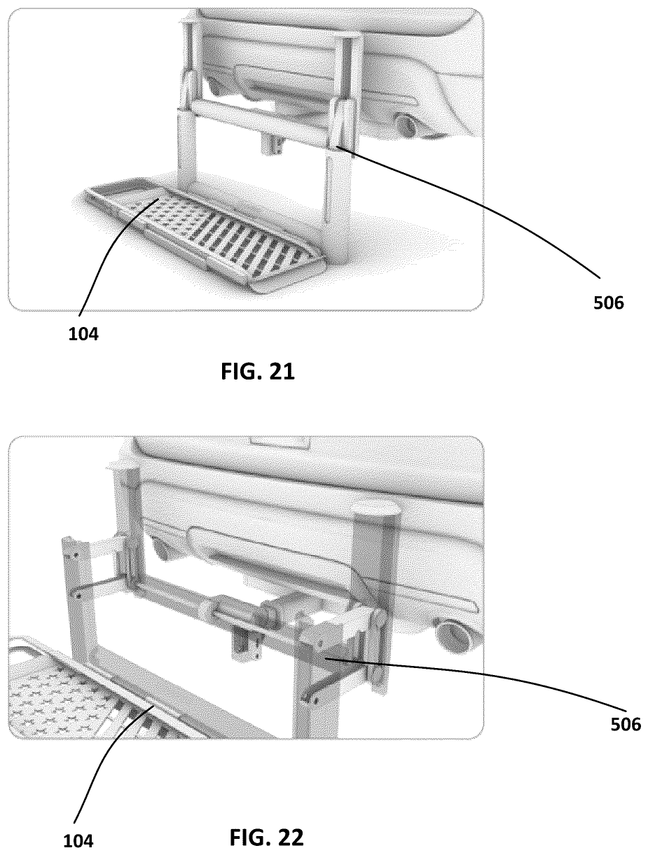

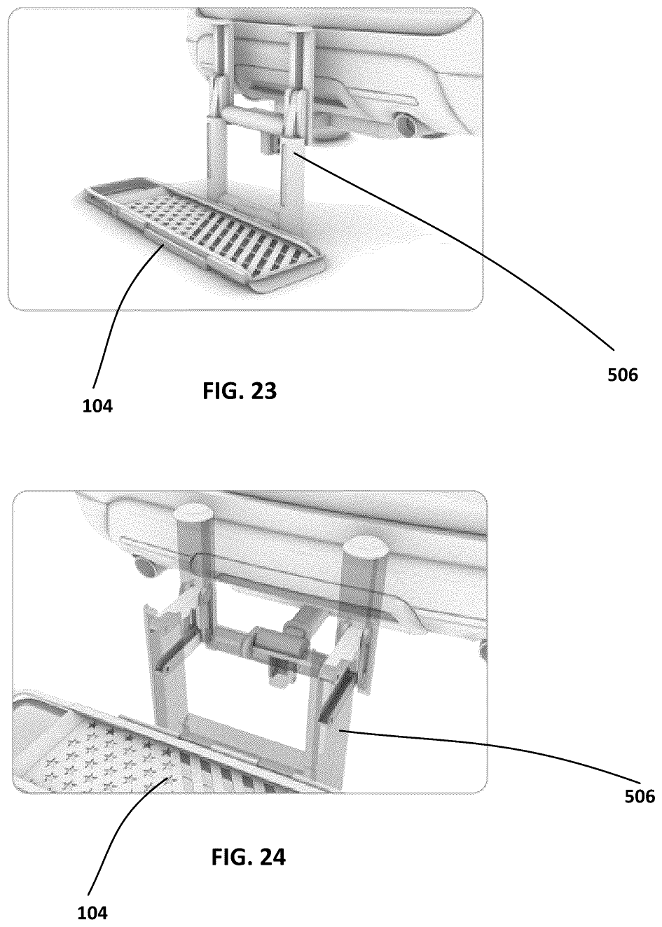

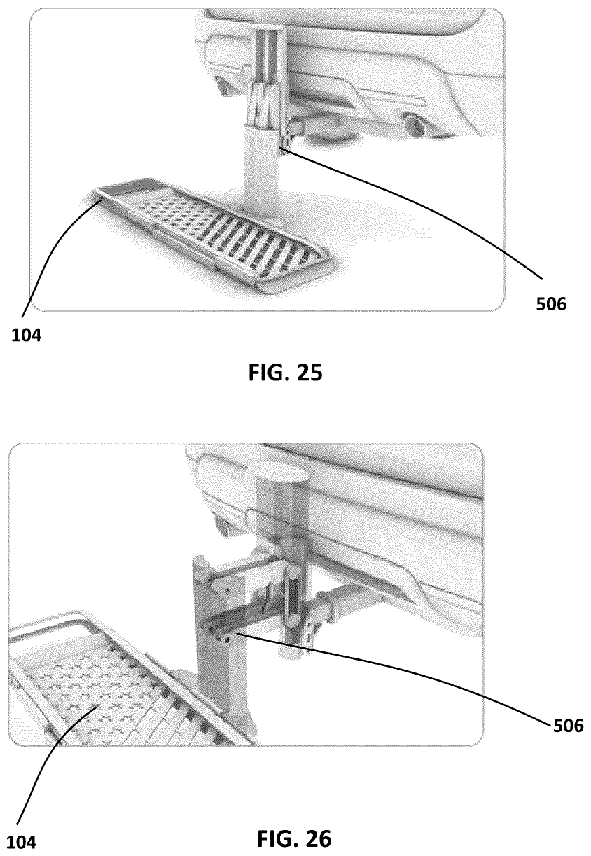

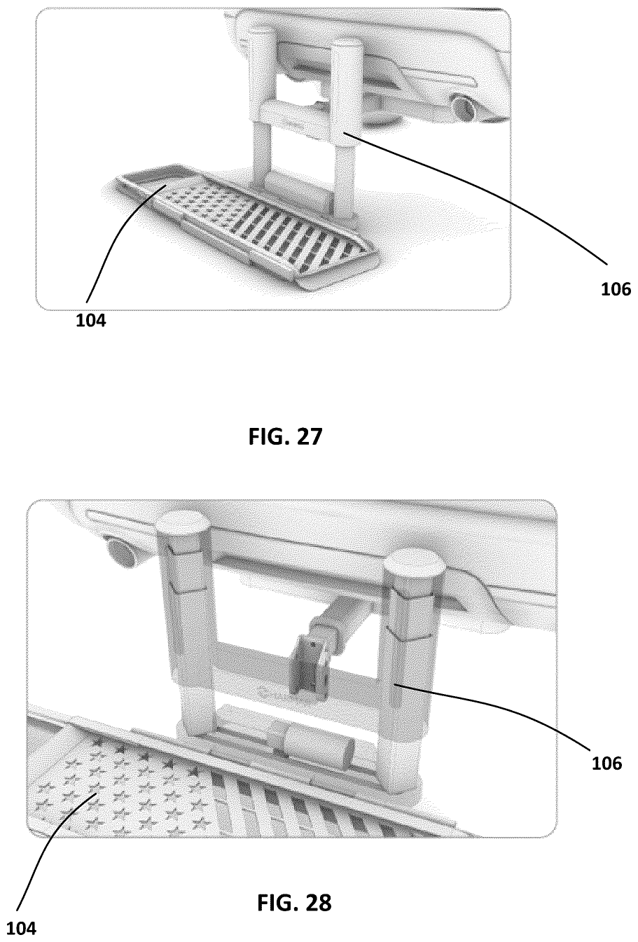

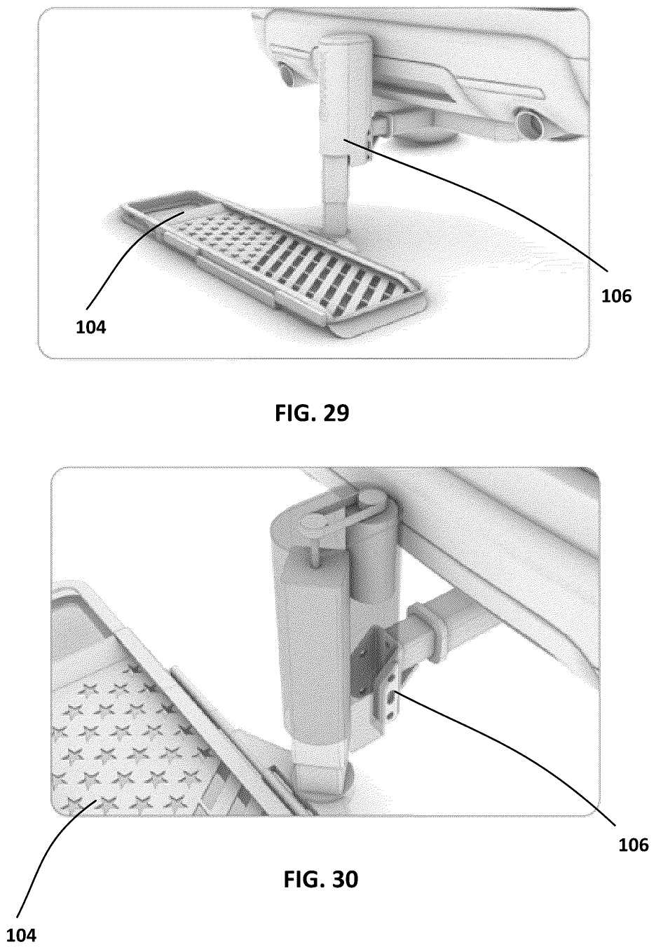

The rotating platform 208 is shown in FIG. 10 in the stowed position and FIGS. 10, and FIGS. 12-16 show the lift system moving from the stowed position to the carrying position. As shown in FIG. 12 the rails 210, 212 are shown rotating outward. FIG. 13 shows the rails 210, 212 rotated fully outward to an open position. FIG. 14 shows the lift system lowered into the loading position and FIG. 15 shows a personal mobility device loaded on to the rails 210, 212. The platform 206 is then shown raised into the carrying position in FIG. 16.

As shown in FIGS. 2 and 11, the lift system 100 can have certain dimensional characteristics while in the stowed position that may allow for increased operability of the lift mechanism and automobile. For example, the distance from the ground to the bottom of the lift system “Y” in some embodiments can be in the range of about 9-14 inches. The distance from the bumper of the automobile to the end of the lift system 100 “X” in some embodiments can be in the range of about 9-20 inches. The distance from the bottom of the lift system to the top of the lift system “H” in some embodiments can be in the range of about 10-22 inches.

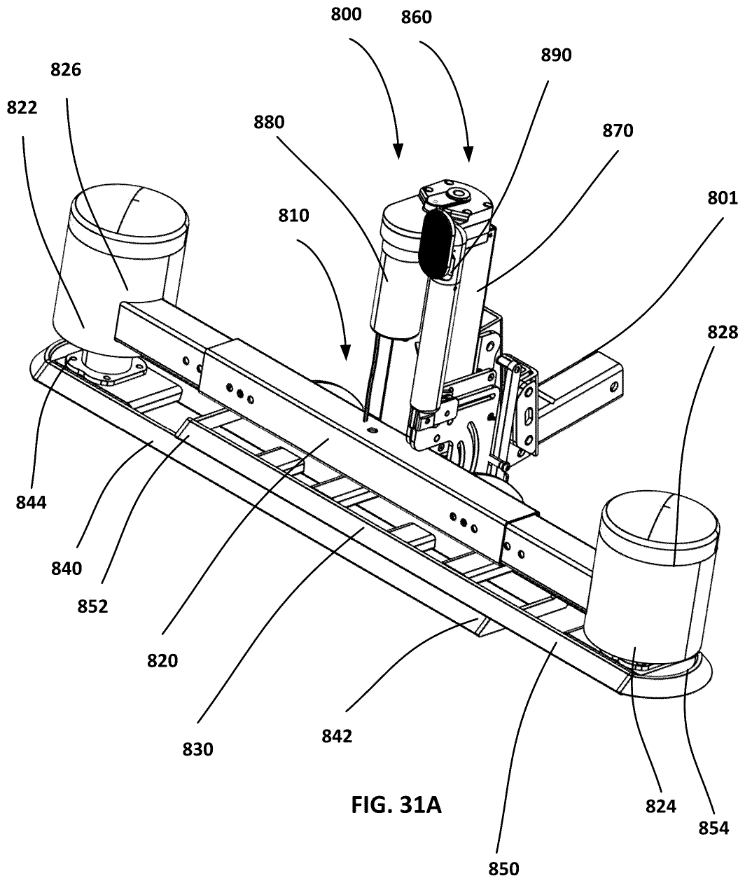

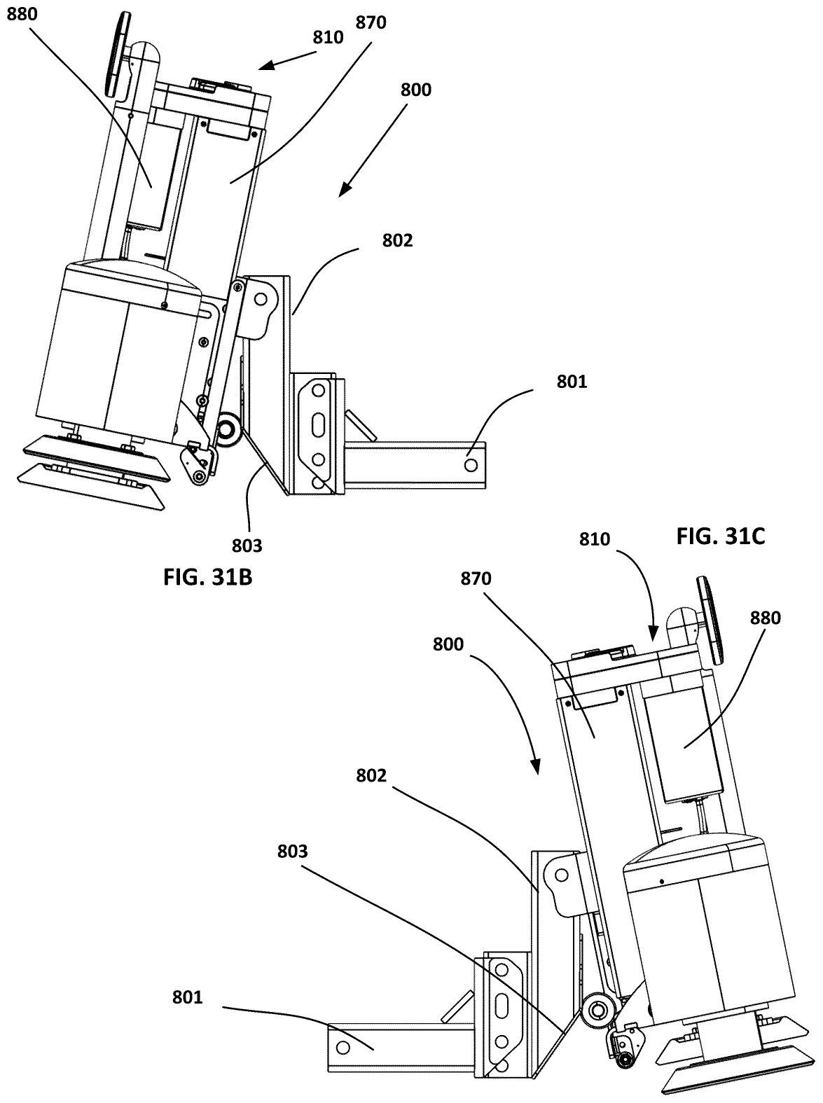

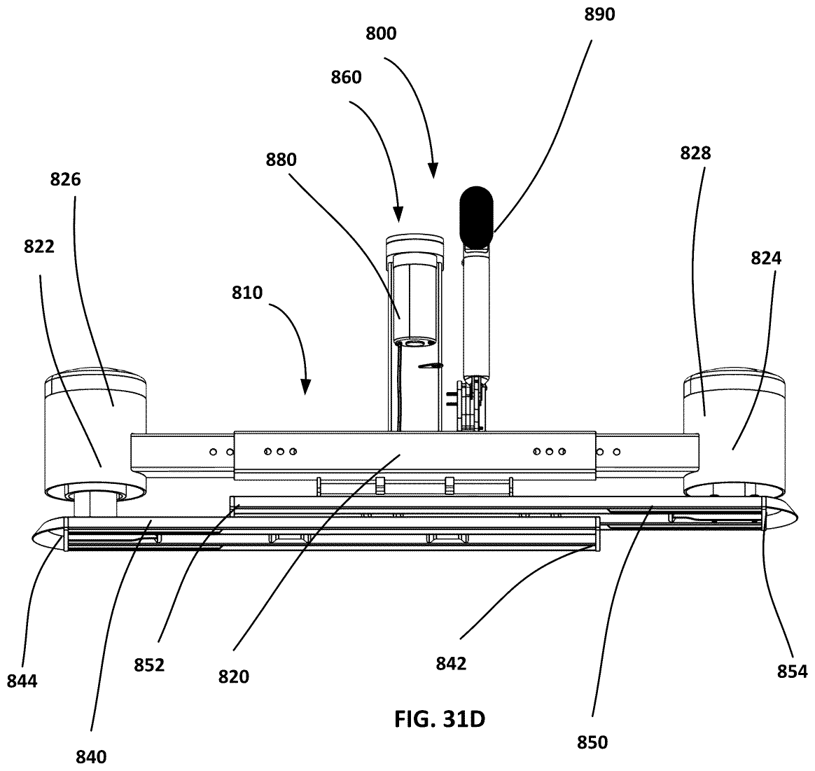

Another embodiment of a lift system 800 in accordance with aspects of the disclosure is shown in FIGS. 31A-34B. The embodiment shown in FIGS. 31A-34B is generally similar to the embodiment shown in FIGS. 10-16.

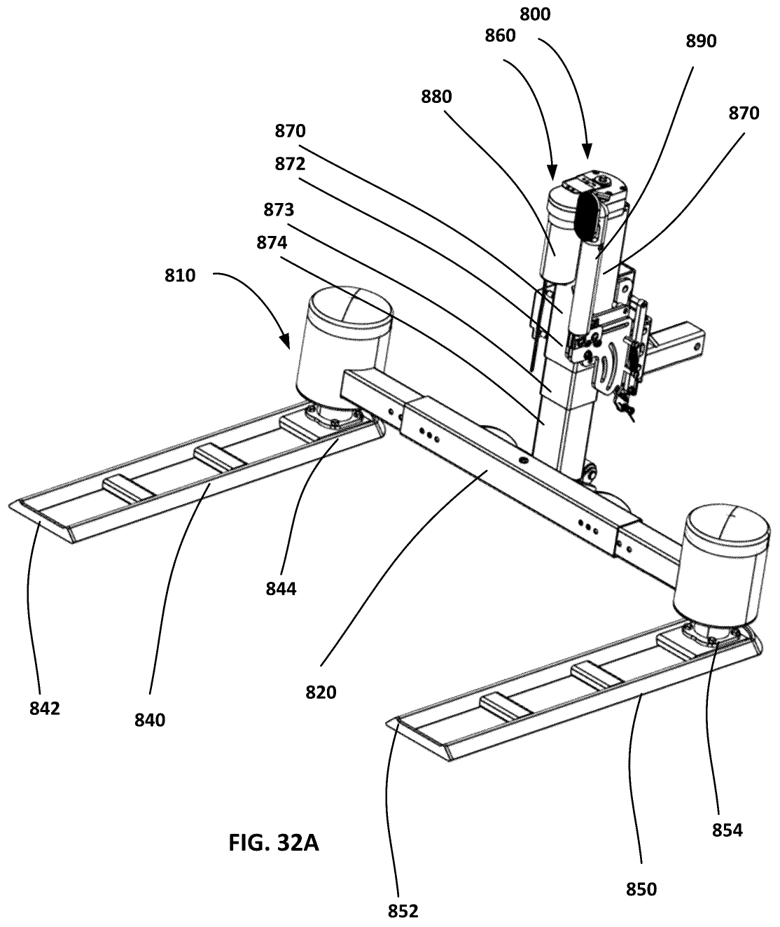

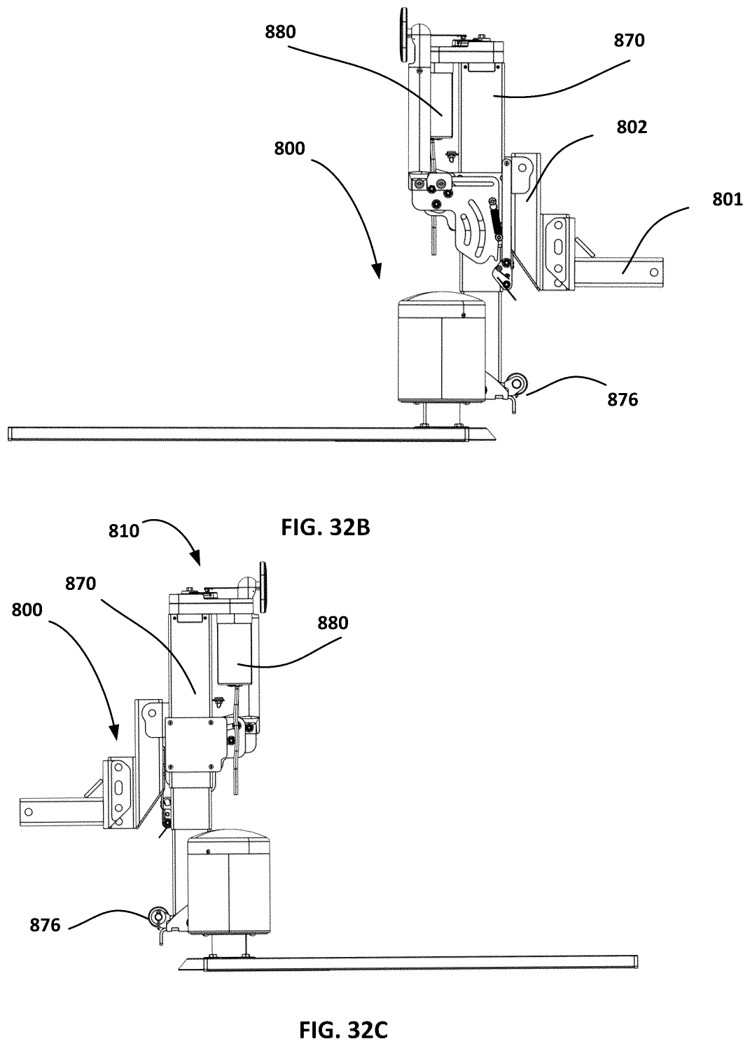

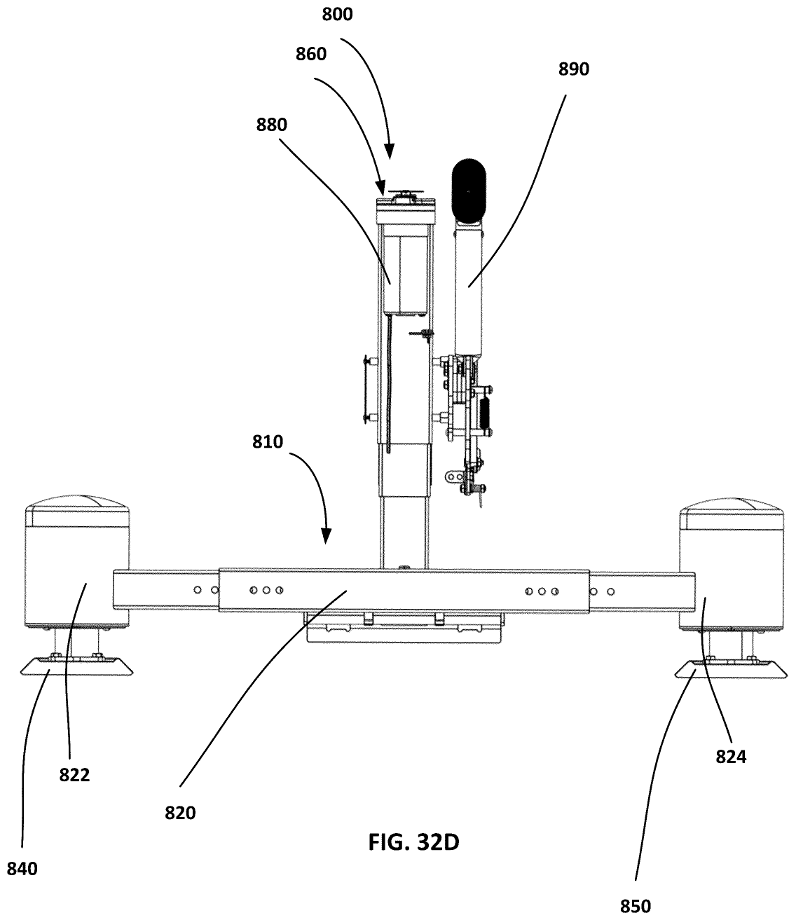

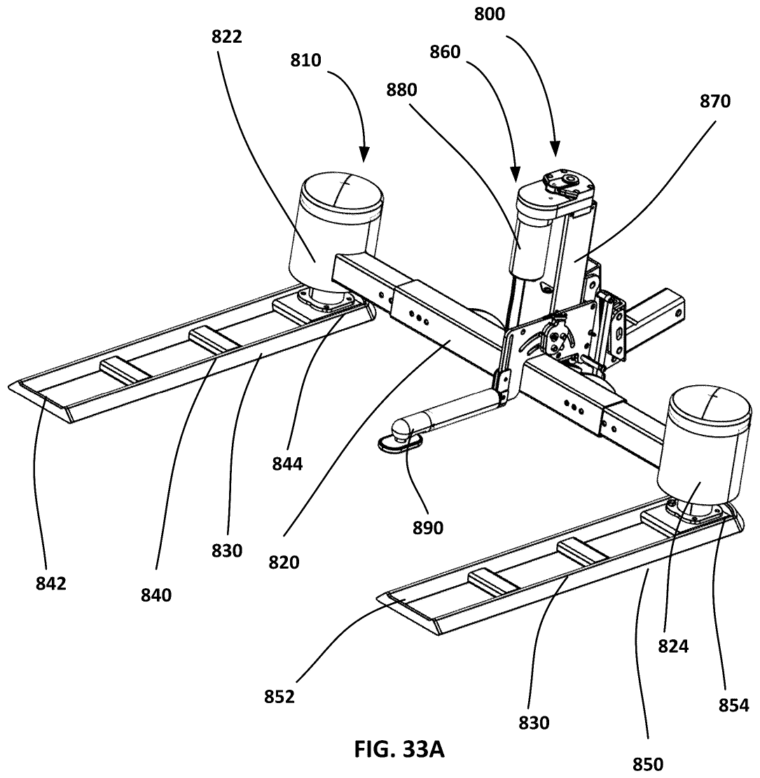

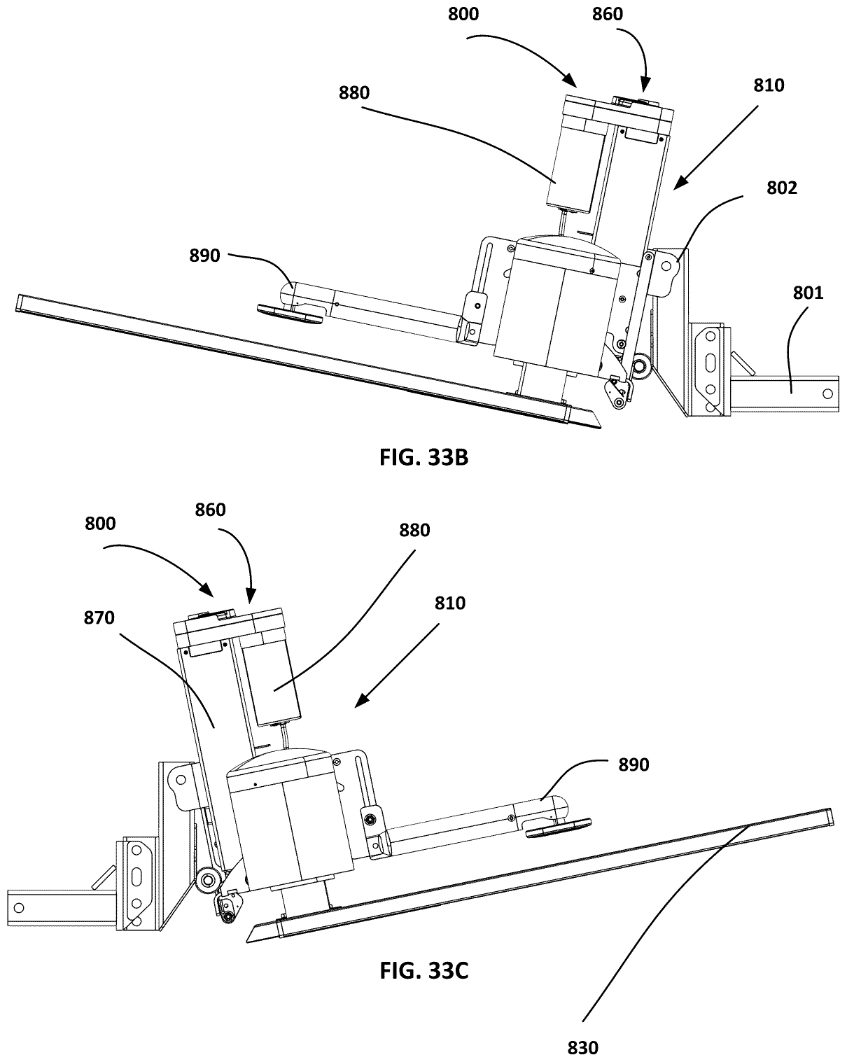

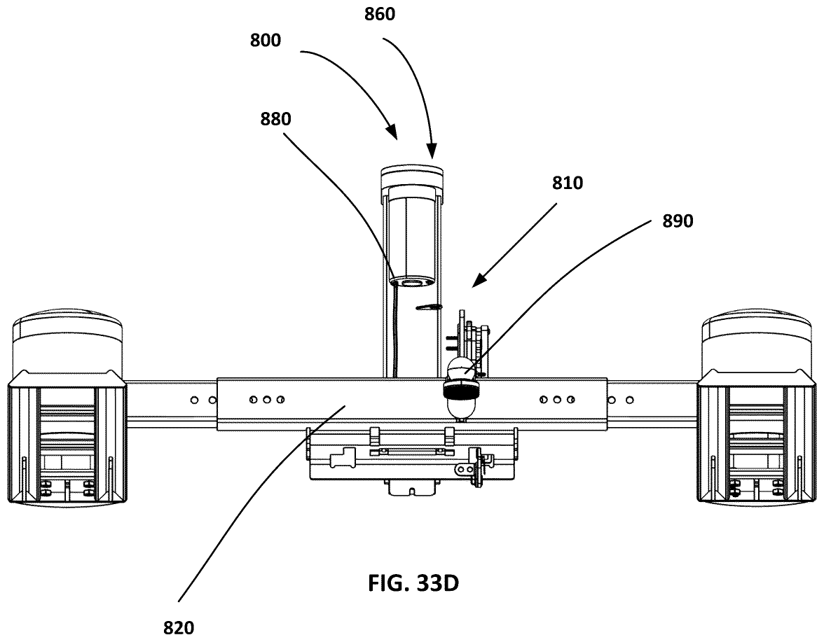

Similar to other embodiments described above, the lift system 800 is configured to engage the rear portion of an automobile (not shown in FIGS. 31A-34B) by inserting a portion of the lift system into a trailer hitch. The lift system includes a lift mechanism and the lift mechanism is configured to move the platform between an upward position (shown for example in a stowed position in FIG. 31A and carrying position in FIG. 33A) and a downward loading position (shown for example in FIG. 32A).

As described above with regard to other embodiments, the embodiment 800 shown in FIGS. 31A-34B, may include a platform 804 that is configured to move between a stowed position (FIGS. 31A-D), wherein the lift system 800 is not carrying a personal mobility device; a loading position (FIGS. 32A-D), wherein personal mobility devices may be loaded on to the platform; and a carrying position (FIGS. 33A-D), wherein the personal mobility device is loaded on to the platform 804 and the automobile may be driven while carrying the personal mobility device.

As described above, the lift system 800 can be configured to allow a user to open the rear door of an automobile while the lift system 800 is in the stowed position. Similarly, the lift system 800 may be below or entirely below the license plate of an automobile when the lift system is in the stowed position. Additionally, the lift system 800 may be below or entirely below the rear window of an automobile when the lift system is in the stowed position. Further, the lift system 800 may be mounted in such a way that it does not block the automobile's rear-view camera when the lift system 800 is connected to the automobile and in the stowed position. Advantageously this allows a user better and safer operation of the automobile by allowing a user easier access to the trunk of the automobile, allowing a user to see out of the rear window and camera of the automobile, and allowing the license plate of the automobile to be visible.

As described above with regard to other embodiments shown in FIGS. 2 and 11, the lift system 800 can have certain dimensional characteristics while in the stowed position that may advantageously allow for increased operability of the lift mechanism and automobile. For example, the distance from the ground to the bottom of the lift system 800 “Y” can be in the range of about 8-12 inches. The distance from the bumper of the automobile to the outward end of the lift system 800 “X” can be in the range of about 9-20 inches. The distance from the bottom of the lift system 800 to the top of the lift system 800 “H” can be in the range of about 10-22 inches.

Referring now to FIGS. 31A-33D, a lift system 800 is shown and described. As described above and shown in reference to other embodiments, the lift system 800 is configured to engage with a rear portion of an automobile. The lift system 800 may include an engagement post 801, configured to engage a hitch of an automobile. The lift system 800 may also include a vertical post 802 engaged with the engagement post 801. As shown in FIGS. 31A-33D, the the vertical post 802 may be adjustably engaged with the engagement post 801 such that a user can adjust the vertical height of the vertical post to accommodate a range of automobiles having different heights. As shown, for example, in FIGS. 31B and 31C the vertical post 802 may include a ramp portion 803. As will be described in more detail below, the ramp portion 803 may allow the lift assembly to tilt backward as it is raised upward.

The lift system 800 also includes a lift assembly 810. The lift assembly 810 is engaged with the vertical post 802. As shown in FIGS. 31A-33D the lift assembly 810 can be pivotally engaged with the vertical post 802 such that the lift assembly 810 the tilt relative to the vertical post 801 as described above. In other embodiments, that may not tilt backward, the lift system 800 may be engaged without a pivotal connection.

The lift assembly 810 includes a support bar 820. The support bar 820 extends substantially horizontally and has a first end 822 and a second end 824. As shown in FIGS. 31A-33D the support bar 810 may be composed of multiple pieces which may be adjustable such that the user can adjust the length of the support bar 810, and thus, adjust the width of the lift assembly 810. As shown in FIGS. 31A-33D the support bar 820 includes a central portion and two outer portions. The distance that the outer portions extend from the central portion may be manually adjustable using apertures in the support bar and mechanical fasteners. In other embodiments, the support bar 810 may be composed of more or fewer pieces. For example, in some embodiments, the support bar may be construct of a single piece which may not be adjustable.

As described above with regard to other embodiments, the lift system 800 may also include a platform for carrying a personal mobility device. As shown in FIGS. 31A-33D the lift assembly 810 includes a platform 830. The platform 830 is divided into two portions. As shown in FIGS. 31A-33D the platform 830 includes a first rail 840 and a second rail 850. The first rail 840 has an outward end 842 and an inward end 844. The inward end 844 is engaged with the first end 822 of the support bar 820. As shown in FIGS. 31A-33D the first rail 840 is rotatably engaged with the support bar 820. The platform 830 also includes a second rail 850. The second rail has an outward end 852 and an inward end 854. The inward end 854 is engaged with the second end 824 of the support bar 820. As shown in FIGS. 31A-33D, the second rail 850 is rotatably engaged with the support bar 820.

As shown in FIGS. 31A-33D the rails 840, 850 are configured to rotate relative to the support bar 820. As best shown in FIGS. 31A-31D, the first rail 840 and the second rail 850 are configured to rotate such that the outwards end of the first rail 842 extends toward the inward end 854 of the second rail 850 and the outward end 852 of the second rail extends toward the inward end 844 of the first rail 840 when the lift assembly 810 is in the stowed position. And as best shown in FIGS. 32A-33D, the first rail 840 and the second rail 850 are configured to rotate such that the outwards ends 842, 852 extend substantially parallel to each other and away from the support bar 820 when the lift assembly 810 is in the loading position and a carrying position. In such a configuration the rails 840, 850 can be substantially perpendicular to the support bar 820.

The height of the rails 840, 850 relative to each other also may be adjustable. As best shown in FIGS. 31A-31D, the first rail 840 is vertically below the second rail 850 when the lift assembly 810 is in the stowed position. And as shown in FIGS. 32A-33D, the rails 840, 850 are at a substantially even height when in the carrying and loading positions.

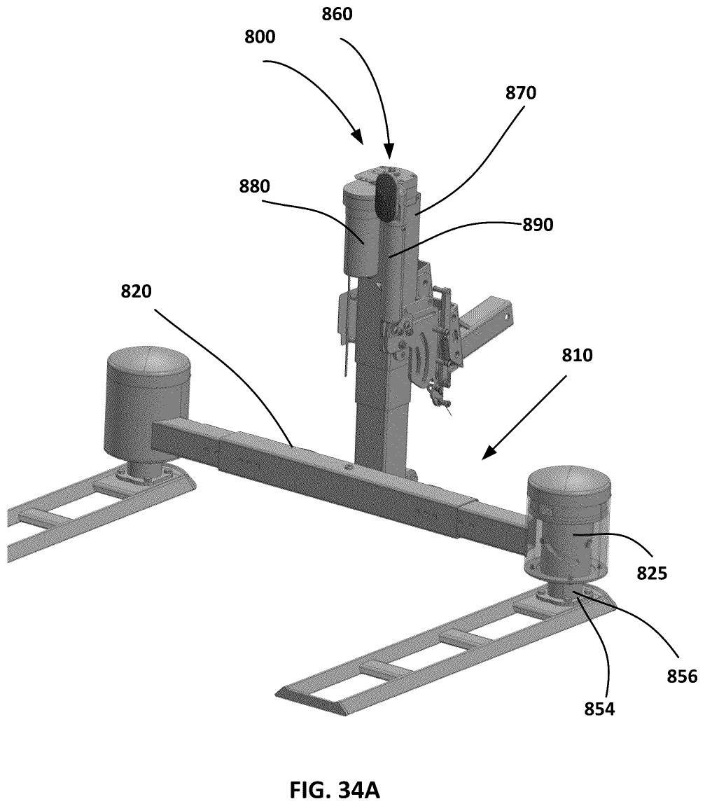

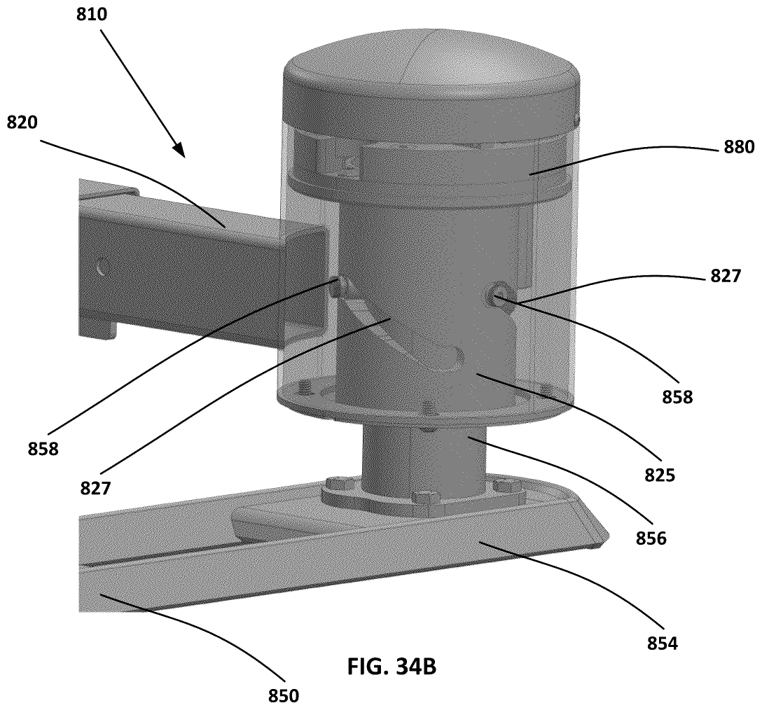

Rotation and vertical adjust of the rails 840, 850 may be manual or may be controlled by drive assemblies. For example, the first end 822 of the support bar 820 can include a first rail drive assembly 826 configured to rotate the first rail 840, and the second end 824 of the support bar 820 can include a second rail drive assembly 828 configured to rotate the second rail 850. The example drive assemblies 826, 828 may comprise any kind of motor capable of moving the rails 840, 850, such as, for example, an electric motor. As described above, the height of the rails 840, 850 relative to each other may also be adjustable which advantageously allows for the rails to be stored in a smaller area when in the stowed position. FIGS. 34A-B, illustrate internal components of the rail 850 and support bar 820 that can allow for vertical displacement of the rail 850. As shown in FIGS. 34A-B, the rail 850 may include a vertically extending shaft 856 on its inward end 854. The shaft 856 may include one or more projections 858 extending from the shaft 856. The shaft 856 extends into a tube 825 engaged with the support bar 820. The tube can include one or more inclined slots 827 and the one or more projections 858 can extend through the slots 827. As the rail 850 is rotated, the projections 858 travel within the slots 827 to thereby vertically displace the rail 850 upward as the rail 850 is rotated to the stowed position and downward in the loading position. In some embodiments the tube 825 and the shaft 856 may be reversed such that the shaft 856 is engaged with the support bar 820 and the tube 825 is engaged with the rail.

As described above with regard to other embodiments, the lift system 800 may also include a lift mechanism for raising a lower in the platform. The lift mechanism 860 includes a telescoping support 870 and a drive assembly 880 configured to extend and retract the telescoping support 870. As shown in FIGS. 31A-33D, the telescoping support 870 includes a plurality of sections 872, 873, 874 with smaller sections nesting within larger sections. Although a system with three sections 872, 873, 874 is shown in FIGS. 31A-33D any suitable number of sections may be used. The example drive assembly 880 may comprise any kind of motor capable of moving the telescoping support 870, such as, for example, an electric motor. As described above the drive assembly 880 can retract and extend the telescoping lift mechanism causing the lift assembly 810 to be moved between a stowed position, a loading position, and a carrying position.

As described above, the lift assembly 810 can be pivotally engaged with the vertical post 802 such that the lift assembly 810 can tilt relative to the vertical post 801. As shown in FIGS. 31A-33D, the lift system 800 can include a roller 880 engaged with telescoping support 870. As telescoping support 870 is raised from a loading position, the roller 880 can engage the vertical post 802. Once the roller engages the ramp portion 803, the lift assembly 810 will tilt backwards when in the stowed and carrying positions.

In some embodiments, the lift system 800 can also include a hold-down bar 890 configured to engage a personal mobility vehicle in the carrying position. The hold-down bar 890 is shown in an upward position in FIGS. 31A-D (stowed position) and FIGS. 32A-D (loading position), and is shown in a downward position in FIGS. 33A-D (carrying position). In some embodiments, the hold-down bar 890 may include one or more sensors or switches 892 that can be used to confirm the hold-down bar is engaged with the personal mobility vehicle.

The lift system 800, and other lift systems described herein, may also include a control system which may control the functioning of the lift system 800. As described herein the control system may control the operation of the lift system 800 and include sensors and or switches to monitor performance of the lift system 800. For example, sensors may monitor current draw and/or temperature of the drive assembly 880, first rail drive assembly 826, and/or second rail drive assembly 828 including their associated motors with a current sensor and/or temperature sensor. The lift system 800 control system may be able to, based on the current draw of the motor, determine a fault condition and indicate the fault condition and/or stop operation of the lift system 800. The control system may enable the user to correct the fault condition. For example, after indicating a fault condition (e.g., an overloaded platform, or obstruction), the control system may stop the platform from moving up, but may enable movement of the platform down.

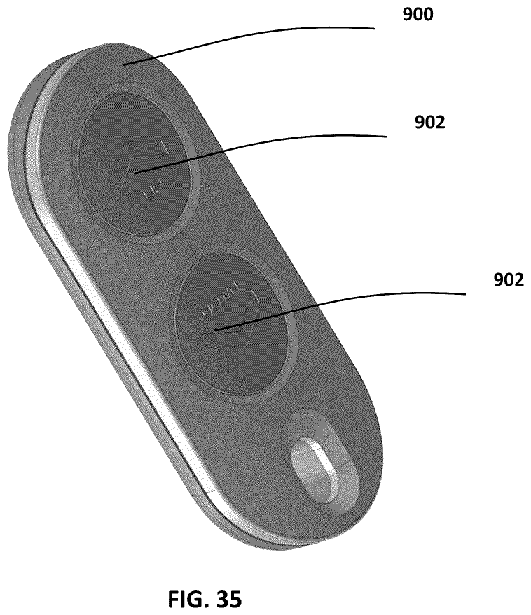

The lift system 800 may have a control system that may control the operation of the lift system 800. The control system may include a controller 900 that may allow user input to control system. The controller 900 may be mounted the lift system 800 or may be separate from the lift system 800. As shown in FIG. 35, the controller 900 may be a keychain or otherwise a small handheld device. The controller 900 may have a switch 902, such as a paddle switch or separate buttons as shown in FIG. 35, to indicate the desired direction of travel of the lift system 800. The switch 902 may be depressed in either an upwards or downwards direction, corresponding to the direction the user wants the lift system 800 to move. The controller 900 may send a signal to the control system based on the direction the switch 902 is depressed. In some examples, the switch 902 may be a constant pressure switch, wherein pressure may be continuously applied to the switch to keep the lift system 800 moving. In some such examples, the control system may be configured to stop and/or reverse the lift system 800 when the pressure paddle is not being depressed.

The controller 900 and lift system 800 may also include systems to prevent accidental operation of the lift system 800. For example, the controller 900 may include a near field communication (NFC) device, radio frequency identification (RFID) device, Bluetooth or other similar device that would be configured to only allow the controller 900 to operate the lift system 800 when the controller is within a specified range of the lift system 800. For example, the controller 900 may only operate the lift system 800 when the controller is within 3 feet of the lift system 800.

The control system and associated sensors may comprise control circuitry, such as, for example, a printed circuit board (PCB). The control circuitry may have one or more processors, memory, and an indicator system. The control circuitry may have configuration inputs for control circuitry customization. The control circuitry may also have a service switch. The control circuitry may be connected to a number of inputs and outputs, including, without limitation: temperature sensor(s), current sensor(s), platform load sensor(s), expansion port(s), and landing switch(es).

In some examples, the control circuitry may be configurable using configuration inputs. The configuration inputs may be used at the time of manufacture to set options for the lift system 800 control system. In some examples, the configuration inputs may be configured using cut-able links on the control circuitry or jump wires. Links on the control circuitry may be cut to disable a circuit or modify the operation of the lift system 800. A circuit that has been disabled by cutting the link on the control circuitry may require soldering to reconnect the link. In examples that use the cut-able links, it may deter tampering and may allow technicians to asses if the control circuitry has been changed from an original configuration.

In some examples, the lift system may have an indicator system that may indicate information received from the control system using visual or audio communication. An audible alarm may be part of the indicator system, and may be triggered in situations such as when an emergency stop button is triggered. The indicator system may also provide visual indicators to indicate that there are no conditions preventing use of the lift system 800, or that a potentially unsafe condition has been detected.

The control system control circuitry may be connected to one or more sensors to measure the status and condition of various parts of the lift system 800. In some examples, drive assembly 880, first rail drive assembly 826, and/or second rail drive assembly 828 may be connected to a temperature sensor and/or a current sensor. Sensor data such as, for example motor temperature and motor current draw may be used by the control system to determine if the lift system 800 is operating outside design parameters. For example, motor temperature that is above a set threshold may be indicative of overheating, may indicate that the motor requires maintenance. Similarly, too high of a current draw from the drive assembly 880, the first rail drive assembly 826, and/or the second rail drive assembly 828 could indicate that the lift assembly 810 or rails 840, 850 impacted an obstacle or that the load is too high while raising or lowering the lift assembly 810, or extending or retracting the rails 840, 850. In such a situation the control system could cause the lift system 800 to stop operating and the user could be alerted to this fault with audible, visual, and/or haptic methods.

If the motor current or temperature moves outside of desired data ranges, the control system may determine a fault condition and change the operation of the lift system 800. The control system may then use an indicator system to indicate, to the user, the fault that has occurred. The temperature of the drive assembly may indicate that the drive assembly may need maintenance or that the lift assembly 810 is overloaded. Similarly, a current sensor may be used to measure the current draw of the drive assembly. A change in current to the drive assembly could also be a sign that maintenance is needed or that the lift assembly 810 is overloaded. Similarly, the motor current sensor can also be used to detect and/or control the operation of the lift system. In some examples the current sensor can be configured to determine whether a personal mobility vehicle is loaded on the lift system. In such a system, the lift system may only be allowed to move to the carrying position when the personal mobility vehicle is detected as loaded. Similarly, the lift system may be configured to stop or change operation of the lift system if the current sensor detects a removal of the personal mobility vehicle which could occur, for example, if the personal mobility vehicle fell from the lift system.

In some examples, the lift system 800, may be powered using its own battery system, connected to a battery system of the automobile it is engaged with, or otherwise powered by the automobile it is engaged with. To conserve power, the control system may switch the lift system 800 to a low power state or sleep mode to conserve energy when the lift system 800 is not in use. The low power state may allow the lift system 800 to maintain battery life as long as possible. The lift system 800 may be configured to enter a lower power state after a set amount of time (e.g., 3-5 minutes) after the last communication or button press from the controller 900. The lift system 800 may exit the low power state when the controller 900 is moved to within a certain distance of the lift system 800 and/or when a button on the controller 900 is pressed.

The various embodiments described herein enable connection of an articulating boom arm. It is also understood that in other embodiments, the various devices, components, and features of the boom arm described herein may be constructed with similar structural and functional elements having different configurations, including different ornamental appearances. Still other benefits may be recognized by those skilled in the art. Accordingly, while the specific embodiments have been illustrated and described, numerous modifications come to mind without significantly departing from the spirit of the invention and the scope of protection is only limited by the scope of the accompanying claims.

1. A lift system configured to engage with a rear portion of an automobile, the lift system comprising:
an engagement post, configured to engage a hitch of an automobile;
a vertical post, the vertical post engaged with the engagement post;
a lift assembly, the lift assembly is engaged with the vertical post, the lift assembly comprising:
a support bar having a first end and a second end;
a platform, the platform comprising:
a first rail having an outward end and an inward end engaged with the first end of the support bar, the first rail rotatably engaged with the support bar; and
a second rail having an outward end and an inward end engaged with the second end of the support bar, the second rail rotatably engaged with the support bar; and
a lift mechanism, the lift mechanism comprising:
a telescoping support; and
a drive assembly, the drive assembly configured to extend and retract the telescoping support;
wherein the lift assembly can be moved between a stowed position, a loading position, and a carrying position.

2. The lift system of claim 1, wherein the first rail and the second rail are configured to rotate such that the outwards ends extend substantially parallel to each other and away from the support bar when the lift assembly is in the loading position.

3. The lift system of claim 2, wherein the first rail and the second rail are configured to rotate such that the outward end of the first rail extends toward the inward end of the second rail and the outward end of the second rail extends toward the inward end of the first rail when the lift assembly is in the stowed position.

4. The lift system of claim 3, wherein the first rail is vertically below the second rail when the lift assembly is in the stowed position.

5. The lift system of claim 1, further comprising a roller engaged with the lift assembly, the roller configured to engage the vertical post.

6. The lift system of claim 1, wherein the lift assembly is pivotally engaged with the vertical post, and wherein the lift assembly is configured to tilt backward in the stowed position.

7. The lift system of claim 1, further comprising a hold-down bar, the hold-down bar configured to engage a personal mobility vehicle in the carrying position.

8. The lift system of claim 7, further comprising a sensor on the hold-down bar, wherein the sensor is configured to sense that hold-down bar is engaged with the personal mobility vehicle.

9. The lift system of claim 1, wherein the first end of the support bar includes a first rail drive assembly configured to rotate the first rail.

10. The lift system of claim 1, wherein the second end of the support bar includes a second rail drive assembly configured to rotate the second rail.

11. The lift system of claim 1, wherein a height of the vertical post relevant to the engagement post is adjustable.

12. The lift system of claim 1, wherein a width of the support bar is adjustable.

13. The lift system of claim 1, wherein the lift system is configured to allow a user to open a rear door of an automobile engaged with the lift system when the lift system is in the stowed position.

14. The lift system of claim 1, wherein the lift system is entirely below a license plate of an automobile engaged with the lift system when the lift system is in the stowed position.

15. The lift system of claim 1, wherein the lift system is entirely below a rear window of an automobile engaged with the lift system when the lift system is in the stowed position.

16. A lift system configured to engage with a rear portion of an automobile, the lift system comprising:
a lift assembly, the lift assembly comprising:
a support bar having a first end and a second end;
a platform, the platform comprising:
a first rail having an outward end and an inward end engaged with the first end of the support bar, the first rail rotatably engaged with the support bar; and
a second rail having an outward end and an inward end engaged with the second end of the support bar, the second rail rotatably engaged with the support bar; and
a lift mechanism, the lift mechanism comprising:
a telescoping support; and
a drive assembly, the drive assembly configured to extend and retract the telescoping support;
wherein the lift assembly can be moved between a stowed position, a loading position, and a carrying position.

17. The lift system of claim 16, wherein the first rail and the second rail are configured to rotate such that the outward ends extend substantially parallel to each other and away from the support bar when the lift assembly is in the loading position.

18. The lift system of claim 16, wherein the first rail and the second rail are configured to rotate such that the outward end of the first rail extends toward the inward end of the second rail and the outward end of the second rail extends toward the inward end of the first rail when the lift assembly is in the stowed position.

19. The lift system of claim 16, further comprising a controller configured to operate the lift assembly by moving the assembly between the stowed position, loading position, and carrying position, wherein the controller is configured to operate the lift assembly only when the controller is within a specified distance from the lift system.

20. The lift system of claim 16, further comprising a controller configured to operate the lift assembly by moving the assembly between the stowed position, loading position, and carrying position, wherein the lift system is configured to enter a lower power state after a set amount of time after a last communication from the controller.

21. The lift system of claim 16, further comprising a current sensor connected to the drive assembly.

22. The lift system of claim 21, wherein the current sensor is configured to determine whether the lift assembly has impacted an obstacle.

23. The lift system of claim 21, wherein the current sensor is configured to determine whether a personal mobility vehicle is loaded on the lift system.

25. A lift system configured to engage with a rear portion of an automobile, the lift system comprising:
a lift assembly, the lift assembly comprising:
a platform;
a lift mechanism engaged with the platform, the lift mechanism comprising:
a telescoping support; and
a drive assembly, the drive assembly configured to extend and retract the telescoping support;
wherein the lift assembly can be moved between a stowed position, a loading position, and a carrying position; and
wherein the lift system has a height measured from a bottom of the lift system to a top of the lift system of about 10 inches to 22 inches when the lift assembly is in the stowed position.
